(19) United States
(12) Patent Application Publication
(10) Pub. No.: US 2025/0073790 A1
(43) Pub. Date: Mar. 6, 2025

(54) CONSTANT LEAD BARREL TOOLING

(71) Applicant: KYOCERA SGS PRECISION TOOLS, INC., Munroe Falls, OH (US)

(72) Inventors: Ian Edward HOLLIDAY, Basingstoke, Hampshire (GB); Robert ROLCZAK, Wokingham, Berkshire (GB); Kamil GLAZA, Reading, Berkshire (GB); Emil DOBOSZ, Wokingham, Berkshire (GB)

(21) Appl. No.: 18/557,803

(22) PCT Filed: Apr. 29, 2022
(86) PCT No.: PCT/US2022/072006

§ 371 Date: Oct. 27, 2023

Related U.S. Application Data
(60) Provisional application No. 63/182,464, filed on Apr. 30, 2021.

(51) Int. Cl. B23C 5/10

(52) U.S. Cl. CPC B23C 5/1009; B23C 2210/0492; B23C 2210/242; B23C 2210/282; B23C 2265/08

(57) ABSTRACT

A constant lead barrel tool that may be reground multiple times.

### RELATED APPLICATIONS

This application claims priority benefit of U.S. Provisional Patent Application Ser. No. 63/182,464 filed Apr. 30, 2021, entitled “Constant Lead Barrel Tooling,” the complete disclosure of which is herein incorporated by reference in its entirety.

### BACKGROUND

Tooling may include variable geometry, such as variable helix. However, it is sometimes difficult to regrind tooling with variable helix. For example, a taper ball nose tool having variable helix geometry may be difficult to regrind. Here, because the cutting edge is not parallel like typical end mills, the lead (pitch) changes as you grind back into the larger diameter, such that its cutting end may need to be cut off and completely reformed.

Accordingly, a need exists for taper ball nose or barrel tooling that is able to offer multiple regrinds.

### SUMMARY

As the name implies, grinding a tool with constant lead geometry allows the pitch to remain the same as the form is pushed back during a regrind/reform operation. The benefit of this is that multiple regrinds can be achieved while maintaining the original (constant lead) geometry as minimal material needs to be removed from the end face during each regrind. In contrast, the helix angle on constant helix barrel tools or taper ball nose tools will reduce after every regrind when removing a minimal amount of material off the end face, meaning the cutting performance of the tool will reduce. Alternatively, more material needs to be removed from the end face to replicate the original geometry meaning less regrinds can be achieved.

It is often necessary to take the tool form back considerably and completely (or almost completely) remove the previous fluting when regrinding, unless the tool has a constant lead geometry. It has been found that regrinding a tool with constant helix geometry will require complete (or almost complete) removal of the previous fluting during a regrind, unlike a tool with constant lead geometry which may only require a minimum removal of previous fluting and still match. Accordingly, incorporating a constant lead geometry on a barrel shape tool is advantageous in that it has the ability to be reground multiple times (i.e., subject to multiple regrind operations) with minimal loss of tool length. This is advantageous in that regrinding a tool extends the operational life span of the tool and thereby provides a significant cost savings.

In accordance with one aspect of the present disclosure a circle segment cutting tool is described. The tool includes a tool body and at least one cutting edge helically extending about the tool body, the at least one cutting edge having a constant lead geometry which may be subject to multiple regrinds. In a further embodiment, at least one cutting edge comprises two or more cutting edges. In another further embodiment, the constant lead geometry of at least one of the cutting edge is different from the constant lead of another of the cutting edges. In another further embodiment, two or more of the cutting edges have the same constant lead. In another further embodiment, the at least one cutting edge comprises a plurality of cutting edges with equal indexing. In another further embodiment, the at least one cutting edge comprises a plurality of cutting edges with unequal indexing. In another further embodiment, the at least one cutting edge has a variable helix angle.

In accordance with another aspect of the present disclosure a barrel tool is described. The barrel tool includes a plurality of constant lead cutting edges helically extending around a tool body. In a further embodiment, the cutting edges wherein the tool body is subject to multiple regrinds. In another further embodiment, the constant lead geometry of at least one of the cutting edges is different from the constant lead of another of the cutting edges. In another further embodiment, two or more of the cutting edges have the same constant lead.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1A illustrates a side view of a tool with constant helix geometry.

FIG. 1B illustrates an end view the exemplary tool with constant helix geometry of FIG. 1A.

FIG. 2A illustrates a side view of an exemplary tool with constant lead (pitch) geometry in accordance with the present disclosure.

FIG. 2B illustrates an end view the exemplary tool with constant Lead (pitch) geometry of FIG. 2A.

FIGS. 3A-3B illustrate the different in pitch (lead) at the same points along the cutting edge of the constant helix tool and the constant lead tool.

FIG. 4 illustrates how the helix angle of the constant lead tool changes when evaluated at different positions along the axis of the tool.

FIG. 5 illustrates a constant lead geometry superimposed on a constant helix geometry.

FIG. 6 illustrates a comparison of constant helix vs constant lead.

### DETAILED DESCRIPTION

The present disclosure is related to milling tools with circle segment geometry (i.e., barrel tools/cutters) and, more particularly, such milling tools with improved regrindability.

The exemplary embodiments described herein provide a constant lead geometry on a tool with circle segment geometry (i.e., a circle segment cutter or barrel tool).

As used herein, “shank” is the cylindrical (non-fluted) part of the tool which is used to hold and locate it in the tool holder. A shank may be perfectly round, and held by friction, or it may have a flat or ground feature that can be used to secure the tool via a mechanical method, e.g., via a set screw. The diameter may be different from the diameter of the cutting part of the tool, so that it can be held by a standard tool holder. The length of the shank might also be available in different sizes.

As used herein, a “flute” is a helical groove running from the tip of the cutting portion (along length L) to the shank. A “tooth” is the sharp blade along the edge of the flute. Generally, the tooth is a wedge shaped feature that is formed during the flute grind operation and cuts away material while chips of the material are pulled by the flute during rotation of the tool.

Circle segment geometry may be provided on various types of cutting tools and such cutting tools with circle segment geometry are referred to as circle segment cutters. Circle segment cutters may have various forms, such as a barrel shape form, a taper shape form, an oval shape form, a lens shape form, etc. In addition, a distal tip of the circle segment cutter may have various geometries, such as a ball nose, a flat face with corner radii leading to the circle segment side profile, etc. Embodiments herein are directed towards a circle segment cutting having improved regrindability. The circle segment cutter tool may comprise a tool body with at least one cutting edge (i.e., tooth) helically extending about the tool body, where the at least one cutting edge has a constant lead geometry. In some examples, the circle segment cutter may have two or more cutting edges, and in such examples, at least one of the cutting edges has a constant lead that is different from the constant lead(s) of one or more of the other cutting edges, and/or two or more of the cutting edges may have the same constant lead. In some examples, at least one cutting edge comprises a plurality of cutting edges with equal indexing, whereas in other examples, the at least one cutting edge comprises a plurality of cutting edges with unequal indexing. In some examples, the circle segment cutting tool is a barrel tool.

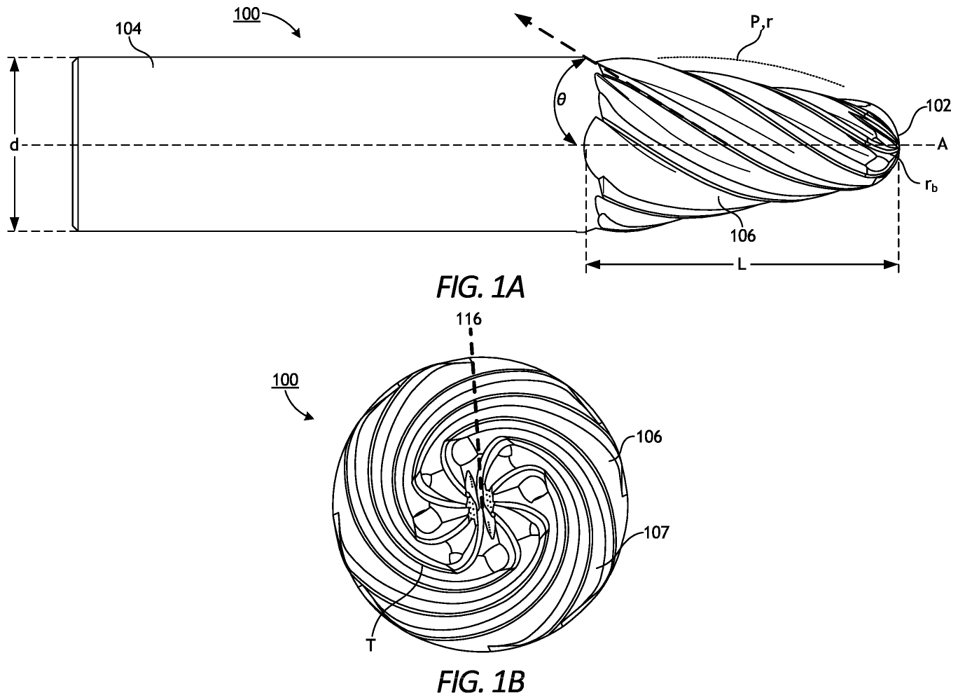

FIG. 1A illustrates a side view of an example constant helix barrel tool 100. The constant helix is presented to illustrate the differences and advantages of the constant lead tool of the present disclosure. As illustrated, the constant helix tool 100 extends along an axis A, from a distal tip 102 towards and into a shank portion 104 defining a tool body. Here, the distal tip 102 includes a ball nose defined by a radius r_{b}. FIG. 1B illustrates an end view of the distal tip 102 of the barrel tool 100 of FIG. 1A.

A side profile along the length of cut of tools with circle segment geometry (i.e., circle segment tools such as the tool 100) are arced or include a radius. Here, for example, a side profile (accentuated in FIG. 1A with peripheral side profile edge line P) evaluated along the length of cut L has an arc shape defined by a radius r. In this example, the radius r of the circle segment geometry is larger than the ball nose radius r_{b} at the distal tip 102. Combining a ball-nose geometry at the distal tip 102 with peripheral large-arc cutting edges (i.e., as shown by peripheral edge P defined by radius r) creates a multi-purpose ‘cutting oval’, which facilitates the use of a barrel end mill as a ball-nose milling tool.

As mentioned, the barrel tool 100 of FIGS. 1A-1B incorporates a constant helix angle geometry, as evaluated from the distal tip 102 of the tool 100 towards the shank 104 of the tool 100. A helix angle θ of the tool 100 in FIGS. 1A-1B remains constant for each cutting edge helically extending around the tool and along the length of cut L, such that the helix angle of each cutting edge helically spiraling around the tool remains constant. However, as most visible in the end view of FIG. 1B, with this constant helix angle geometry, the pitch (lead) changes with diameter d of the tool 100 (i.e., the pitch (or lead) changes along the length of cut L as the diameter d increases from tip 102 towards the shank 104. Flute spacing (volumetric) generally increases along the length of cut L due to a number of variables, such as tapered core, flute wheel size/shape/path, land width size, etc. For example, the spacing in flutes 106 and 107 varies considerably at different locations along the length of cut L and as the diameter d of the tool 100 expands as it is evaluated from the distal end 102 towards the shank 104 (i.e., proximally from the distal end 102) due to unequal indexing. Thus, maintaining the helix angle θ of the tool 100 at a constant value results in the lead increase as the diameter d increases.

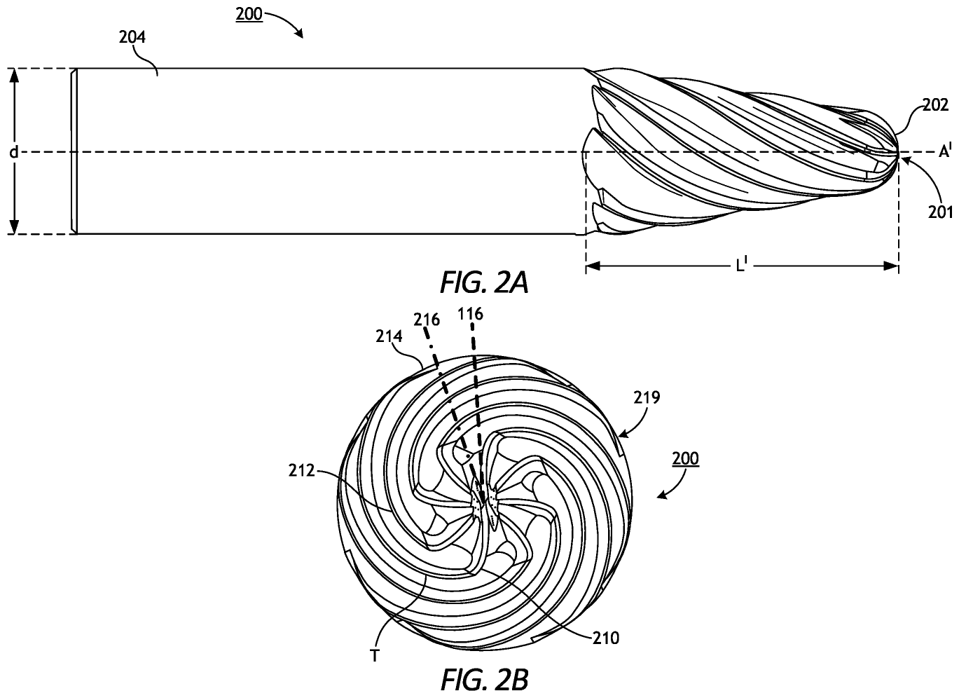

FIG. 2A illustrates a side view of an example constant lead (or constant pitch) barrel tool 200, which may incorporate the principles of the present disclosure. As illustrated, the tool 200 extends along an axis A′, from a distal tip 202 towards and into a shank portion 204. Here, the distal tip 202 comprises a ball nose tip 201. FIG. 2B is an end view of the distal tip 202 of the barrel tool 200 of FIG. 2A. In particular, FIG. 2B illustrates the constant lead tool 200 for comparing tooth configuration with respect to the constant helix tool 100. In FIG. 2B, the tooth T′ of the constant lead tool 200 is illustrated having a starting point 210, a middle point 212, and an end point 214 proximate to the outer periphery 219 of the tool 200. Line 216 is representative of the endpoint 214 of the tooth T′ of constant lead tool 200, as compared to an end point of a tooth T of a constant helix tool 100 as represented by line 118, such that the tool 200 may be compared the tool 100.

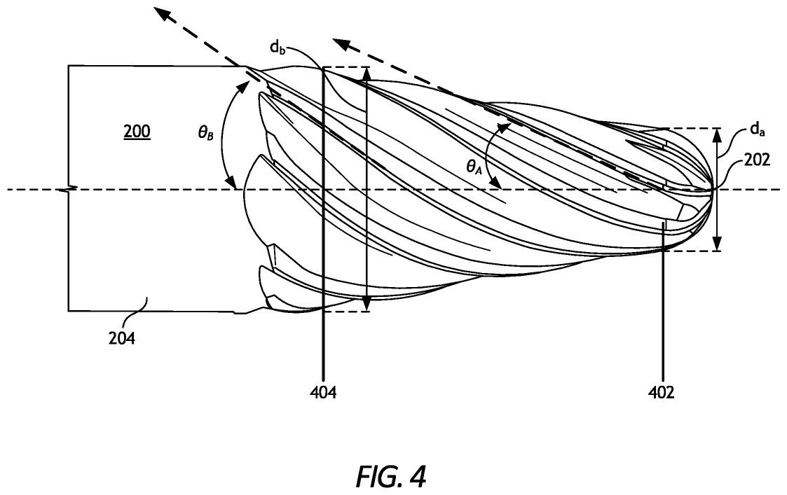

As mentioned, the barrel tool 200 of FIGS. 2A-2B has a constant lead or pitch (i.e., the degree of radial separation between the cutting edges at a given point along the length of cut), as evaluated from a distal tip of the tool towards a shank of the tool. Thus, the radial separation between cutting edges of the tool 200 remains constant along the length L′ of cut. For example, the flute spacing shown of the tool 200 in FIG. 2B is relatively uniform/constant along the length of cut L′, whereas the degree of radial separation between each tooth (or index angle) of the tool 100 varies as shown in FIG. 1B due to unequal index of the teeth T. However, as described in greater detail with respect to FIG. 4, the helix angle of each cutting edge varies as the diameter d′ of the tool 200 increases. For example, the helix angle of a cutting edge evaluated along the length of cut L′ at a position proximate to the shank 204 is greater than the helix angle of that same cutting edge evaluated at a position distally therefrom (i.e., closer to the distal tip 202).

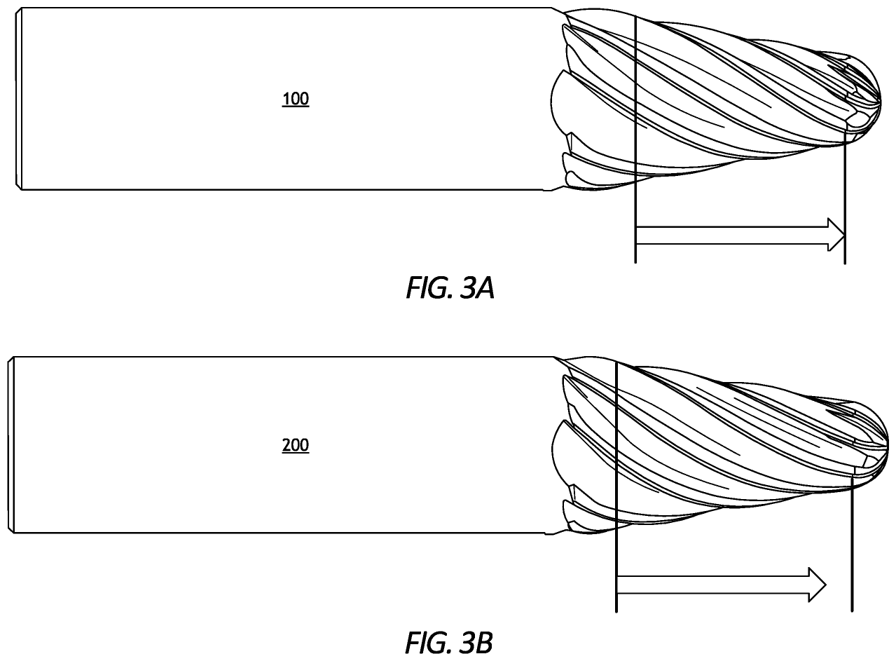

FIGS. 3A-3B illustrate the differences in pitch (lead) at the same points along the cutting edge of the constant helix tool 100 and the constant lead tool 200. When trying to regrind a constant helix on a taper tool, such as the constant helix taper tool 100 of FIG. 3A, the cutting edge will not align. In these cases, typically more material has to be removed to clean up the existing form, thereby resulting in a decreased number of available regrinds, typically limited to only one regrind.

This is because the helix angle θ on constant helix barrel tools or taper ball nose tools will reduce after every regrind when removing a minimal amount of material off the end face, meaning the cutting performance of the tool will reduce, and to remedy this deficiency, more material needs to be removed from the end face (the length of cut being shorted from the cutting end of the tool opposite of the shank end) to replicate the original geometry meaning less regrinds can be achieved.

However, with a constant lead (pitch) tool such as the tool 200 illustrated in FIG. 3B, the pitch (lead) will remain the same as the form is pushed back/rearward (towards the shank 204) during a regrind or reform operation. This provides numerous benefits. For example, multiple regrinds can be achieved while maintaining the original geometry (constant lead) as minimal material needs to be removed from the end face each regrind.

FIG. 4 illustrates how the helix angle of the constant lead tool 200 changes when evaluated at different positions along the axis A′. For example, the helix angle increases when evaluated at positions further away from the distal tip 202 (i.e., closer to the shank 204). Thus, the helix angle will be greater when evaluated at positions along the axis A′ where the tool diameter is greater. For example, position 402 represents a position on the tool 200 that is approximately 5 mm from the distal tip 202, whereas position 404 represents a position on the tool 200 that is approximately 25 mm from the distal tip 202. At position 402, the tool diameter d_{A} is approximately 9 mm and the helix angle θ_{A} is approximately twenty-five degrees (25°). At position 404, the tool diameter d_{B} is approximately 16 mm and the helix angle θ_{B} is approximately thirty-eight degrees (38°).

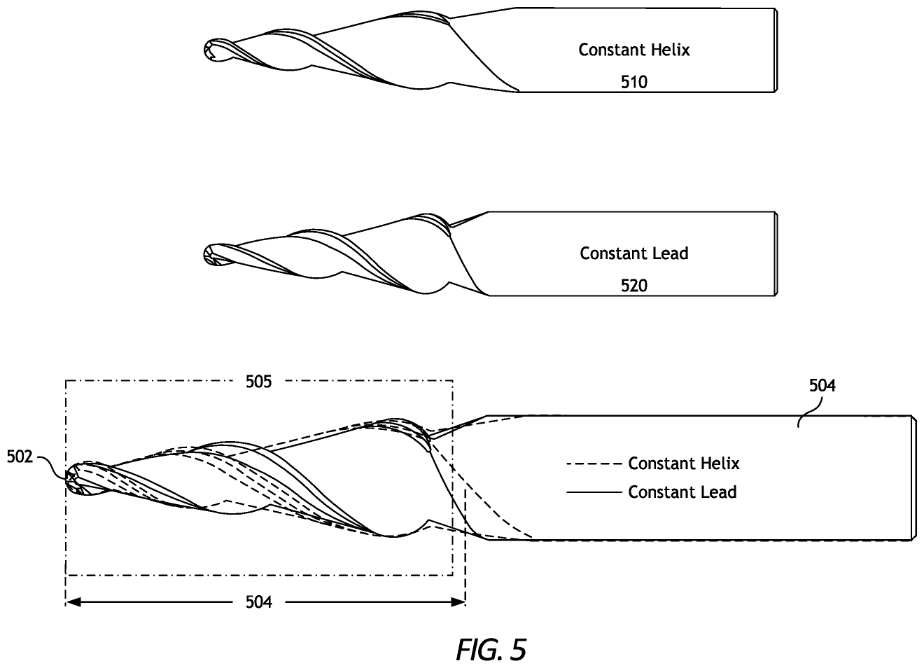

FIG. 5 illustrates a constant lead geometry 520 superimposed on a constant helix geometry 510. As shown, there is considerable variance (divergence) in the helix angle of the constant helix geometry 510 as compared to the constant lead geometry 520 at locations along the tool's length of cut 504 proximate to the distal tip 502, and there is there is considerable variance (divergence) in the helix angle of the constant helix geometry 510 as compared to the constant lead geometry 520 at locations of the tool's length of cut proximate to the shank 504. However, at a point along the tool's length of cut somewhere between the distal tip 502 and the shank 504 (i.e., a midpoint), the helix angle of the constant helix geometry tool and the helix angle of the constant lead geometry tool will match. This demonstrates that, without constant lead geometry 520, the fluting cannot be matched during a regrind without taking the cutting form 505 back a considerable amount to fully/completely remove the previous fluting. Thus, unlike the constant lead geometry 520 which only requires a minimal amount of form removal during a regrind, constant helix geometry 510 requires a large amount of form removal to remove the previously fluting completely. Accordingly, using a constant lead tool geometry 520 on a barrel shaped tool provides the tool with the ability to be subject to multiple regrinds with minimal loss to the tool's length of cut, thereby resulting in considerable cost savings.

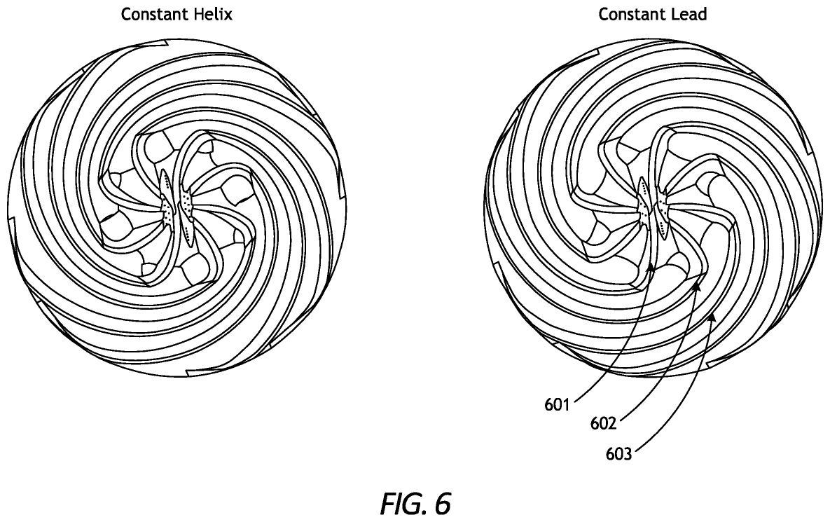

FIG. 6 illustrates a comparison of the constant lead tool 200 and constant helix tool 100. While embodiments disclosed herein are described with reference to tools with constant lead which is the same on all teeth 601, 602, 603 (e.g., first tooth 601 has 60 mm lead, second tooth 602 has 60 mm lead, third tooth 603 has 60 mm lead, etc.), the embodiments disclosed herein may be provided on tools having a constant lead along each tooth 601, 602, 603 but which can change from tooth to tooth (e.g., first tooth 601 has 60 mm lead, second tooth 602 has 65 mm lead, third tooth 603 has 62 mm lead, etc.). Essentially the lead may be the same or different from one tooth to the next, but it remains constant on the same tooth along the length of cut L′. Thus, embodiments of the present disclosure may be provided on tools having equal or unequal indexing.

While embodiments herein are sometimes described and illustrated with reference to a tool having a constant degree of radial separation between the teeth, embodiments herein may be provided on tools that do not have a constant degree of radial separation between teeth.

Aspects of the present disclosure may be embodied on a tool having various numbers of flutes and other characteristics/geometries. For example, in the case of a tool having four flutes (i.e., a four-flute tool), such tool may have various geometries. A four-flute tool with constant lead (e.g., 60/60/60/60 mm on all teeth) with equal index (i.e., 90/90/90/90 degrees radial separation between teeth) would have the same degree of radial separation tooth to tooth and along the length of cut. A four-flute tool with constant lead (e.g., 60/60/60/60 mm on all teeth) with unequal index (e.g., 85/95/85/95 degrees) would have a different degree of radial separation tooth to tooth but constant along the length of cut of each tooth. A four-flute tool with constant lead along each tooth but varying between teeth (e.g., 60/65/60/65 mm) with equal index (e.g., 90/90/90/90 degrees) would have different degree of radial separation tooth to tooth and along the length of cut of each tooth. A four-flute tool with constant lead along each tooth but varying between teeth (e.g., 60/65/60/65 mm) with unequal index (e.g., 85/95/85/95 degrees) would have different degree of radial separation tooth to tooth and along the length of cut of each tooth. It will be appreciated, however, that the foregoing are merely examples circle segment cutting tools having the constant lead geometry as described herein, and that the constant lead geometry may be provided on circle segment cutting tools with other characteristics (i.e., more or less than four flutes, different lead(s), combinations of teeth with same or different leads or index, etc.). As used herein, the term “lead” is the axial/linear advancement of a helical cutting edge during one complete turn (i.e., 360°) (i.e., the length of an individual cutting edge or tooth when unwound from its helical path into a straightened length and measured on an axis). The term “constant lead” means that for every degree of rotation, the linear travel/length of the cutting edge/tooth is the same no matter from where you measure such travel. One or more teeth/cutting edges may have the same or different constant lead.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

The terms “proximal” and “distal” are defined herein relative to a tool operator or CNC machine having an interface configured to mechanically couple a tool to a spindle. The term “proximal” refers to the position of an element closer to the operator or CNC machine and the term “distal” refers to the position of an element further away from the operator or CNC machine. Moreover, the use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

In this document, relational terms such as first and second, top and bottom, greater than and less than, and the like may be used solely to distinguish one entity or action from another entity or action without necessarily requiring or implying any actual such relationship or order between such entities or actions.

To aid the Patent Office and any readers of this application and any resulting patent in interpreting the claims appended hereto, applicants do not intend any of the appended claims or claim elements to invoke 35 U.S.C. 112(f) unless the words “means for” or “step for” are explicitly used in the particular claim.

What is claimed is:

1. A circle segment cutting tool, comprising:
a tool body,
at least one cutting edge helically extending about the tool body, the at least one cutting edge having a constant lead geometry which may be subject to multiple regrinds.

2. The circle segment cutting tool of claim 1, wherein the at least one cutting edge comprises two or more cutting edges.

3. The circle segment cutting tool of claim 2, wherein the constant lead geometry of at least one of the cutting edge is different from the constant lead of another of the cutting edges.

4. The circle segment cutting tool of claim 2, wherein two or more of the cutting edges have the same constant lead.

5. The circle segment cutting tool of claim 1, wherein the at least one cutting edge comprises a plurality of cutting edges with equal indexing.

6. The circle segment cutting tool of claim 1, wherein the at least one cutting edge comprises a plurality of cutting edges with unequal indexing.

7. The circle segment cutting tool of claims 1-6, wherein the at least one cutting edge has a variable helix angle.

8. The circle segment cutting tool of claim 1, wherein the at least one cutting edge has a helix angle that that increases along a length of the tool away from a distal tip.

9. The circle segment cutting tool of claim 8, wherein at about 5.0 mm from the distal tip, the helix angle is about 25 degrees.

10. The circle segment cutting tool of claims 8 and 9, wherein at about 25 mm from the distal tip, the helix angle is about 38 degrees.

11. The cutting tool of claim 1, wherein the constant lead geometry of at least one of the cutting edges is different from a constant lead of another of the cutting edges.
